(19) United States
(12) Patent Application Publication
(10) Pub. No.: US 2023/0292110 A1
(43) Pub. Date: Sep. 14, 2023

(54) METHOD AND LIGHT DEVICE FOR PROGRAMMING LIGHT DEVICE VIA ENCRYPTED COMMUNICATION

(71) Applicant: SOLUM CO., LTD., Yongin-si (KR)

(72) Inventor: Sun Ik KIM, Suwon-si (KR)

(21) Appl. No.: 18/177,098

(22) Filed: Mar. 1, 2023

(30) Foreign Application Priority Data
Mar. 8, 2022 (KR) 10-2022-0029522

(51) Int. Cl. H04W 12/033; H05B 47/19; H05B 47/165

(52) U.S. Cl. CPC H04W 12/033; H05B 47/19; H05B 47/165

(57) ABSTRACT

The method for programming a lighting device via encrypted communications includes pairing the lighting device with a user device to connect first radio frequency (RF) communications, receiving information necessary for second encrypted RF communications by a first memory of the lighting device via the first RF communications, connecting second encrypted RF communications between the lighting device and the user device by using the information necessary for the second encrypted RF communications, and receiving encrypted lighting device setting information via the second encrypted RF communications.

### CROSS-REFERENCE TO RELATED APPLICATION AND CLAIM OF PRIORITY

This application claims the benefit under USC § 119 of Korean Patent Application No. 10-2022-0029522 filed on Mar. 8, 2022 in the Korean Intellectual Property Office, the disclosure of which is incorporated herein by reference in its entirety.

### BACKGROUND

### 1. Field

The present disclosure relates to a lighting device and a method for programming a lighting device via encrypted communications.

### 2. Description of Related Art

LED lighting, a product that replaces traditional lighting, has rapidly replaced all traditional lighting devices. LED lighting fixture manufacturers require an efficient manufacturing process that may change setting values of power supplies according to customers' order specifications. Therefore, functions that may be applied to any stage of a manufacturing process and that may set products with specifications desired by the customers by programming easily and quickly through wireless programming technology have been required and LED lighting fixture manufacturers may be able to reduce costs and inventory and process customer orders faster.

In the related art, data is transmitted through unencrypted wired/wireless communications and immediately stored in a non-volatile memory. When a communication network is attacked, the non-volatile memory in which the data is stored is immediately attacked, resulting in data leakage and manipulation by an attacker. Therefore, there is a need for a method of storing only safely transmitted data in a non-volatile memory without leakage in the process of directly transferring data.

In particular, for direct data transmission, wireless communication using near-field communication (NFC) and wired communication using universal asynchronous receiver/transmitter (UART) are mainly used, but the two representative communication methods are very vulnerable to data manipulation and external leakage because communications are performed in an unencrypted state.

Recently, in order to enhance the security of IoT devices, memory regions (e.g., non-volatile memory) storing various security authentication keys and device setting information are protected through encryption not to be easily analyzed by attackers. However, a procedure for transferring data to store data, there is no preparation for external leakage, so the possibility of external leakage is very high.

### SUMMARY

Exemplary embodiments provide a lighting device and a method for programming a lighting device via encrypted communications, capable of preventing information leakage through the use of non-encrypted communications by receiving information necessary for accessing a second network through near-field communication (NFC) and storing various security authentication keys and device setting information located in the second network via encrypted communications using the received information.

According to an aspect of the present disclosure, a method for programming a lighting device via encrypted communications includes: pairing the lighting device with a user device to connect first radio frequency (RF) communications; receiving information necessary for second encrypted RF communications by a first memory of the lighting device via the first RF communications; connecting second encrypted RF communications between the lighting device and the user device by using the information necessary for the second encrypted RF communications; and receiving encrypted lighting device setting information via the second encrypted RF communications.

According to another aspect of the present disclosure, a lighting device for performing programming via encrypted communications includes a near-field communication (NFC) device performing first radio frequency (RF) communications for receiving information necessary for second encrypted RF communications; an RF transceiver performing pairing through information necessary for the second encrypted RF communications and receiving encrypted lighting device setting information after completing the second encrypted RF communications pairing; and a power unit receiving power from the outside according to the encrypted lighting device setting information and supplying power to at least one light source.

### BRIEF DESCRIPTION OF THE DRAWINGS

The above and other aspects, features, and advantages of the present disclosure will be more clearly understood from the following detailed description, taken in conjunction with the accompanying drawings, in which:

FIG. 1 is a block diagram schematically illustrating connections between components of a lighting device performing programming via encrypted communications according to an exemplary embodiment in the present disclosure;

FIG. 2 is a conceptual diagram illustrating pairing between a lighting device performing programming via encrypted communications and a user device according to an exemplary embodiment in the present disclosure;

FIG. 3A is a block diagram schematically illustrating connections between components of a lighting device performing programming via encrypted communications according to an exemplary embodiment in the present disclosure;

FIG. 3B illustrates a near-field communication (NFC) data exchange format (NDEF) structure used for first RF communications according to an exemplary embodiment in the present disclosure;

FIG. 4 illustrates a process in which a lighting device performing programming via encrypted communications performs transmission and reception according to an exemplary embodiment in the present disclosure;

FIG. 5 illustrates a process in which a lighting device performing programming via encrypted communications performs transmission and reception according to an exemplary embodiment in the present disclosure; and

FIG. 6 illustrates a method for programming a lighting device via encrypted communications according to an exemplary embodiment in the present disclosure.

### DETAILED DESCRIPTION

Prior to the description of the present invention, terms and words used in the present specification and claims to be described below should not be construed as limited to ordinary or dictionary terms, and should be construed in accordance with the technical idea of the present invention based on the principle that the inventors can properly define their own inventions in terms of terms in order to best explain the invention. Therefore, the embodiments described in the present specification and the configurations illustrated in the drawings are merely the most preferred embodiments of the present invention and are not intended to represent all of the technical ideas of the present invention, and thus should be understood that various equivalents and modifications may be substituted at the time of the present application.

Hereinafter, embodiments of the present invention will be described in detail with reference to the accompanying drawings. In this case, in the drawings, the same components are denoted by the same reference symbols as possible. Further, the detailed description of well-known functions and constructions which may obscure the gist of the present invention will be omitted. For the same reason, some of the elements in the accompanying drawings are exaggerated, omitted, or schematically illustrated, and the size of each element does not entirely reflect the actual size.

Hereinafter, exemplary embodiments of the present disclosure will be described in detail based on the accompanying drawings.

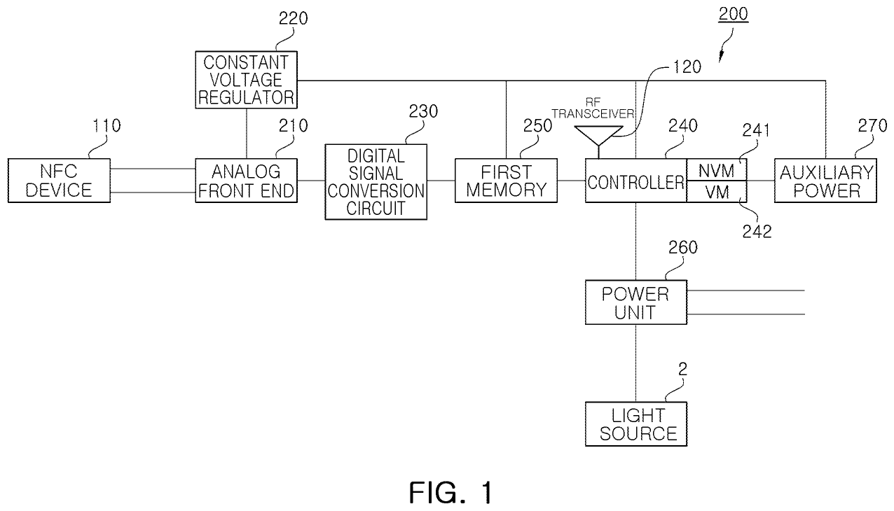

FIG. 1 is a schematic block diagram illustrating connections between components of a lighting device 200 performing programming via encrypted communications according to an exemplary embodiment in the present disclosure.

As illustrated in FIG. 1, a lighting device 200 according to an exemplary embodiment in the present disclosure may include a near-field communication (NFC) device 110 performing first radio frequency (RF) communications for receiving information necessary for second encrypted RF communications, an RF transceiver 120 performing pairing through information necessary for the second encrypted RF communications and receiving encrypted lighting device setting information after completing the second encrypted RF communications pairing, and a power unit 260 receiving power from the outside according to the encrypted lighting device setting information and supplying power to at least one light source 2.

In addition, the lighting device 200 according to an exemplary embodiment in the present disclosure may include a controller 240 including a non-volatile memory (NVM) 241 storing the received encrypted lighting device setting information and a volatile memory (VM) 242 storing decrypted lighting device setting information, and controlling an operation of the power unit 260 according to the received lighting device setting information. VM 242 according to an embodiment in the present may include, for example, a static random access memory (SRAM.)

In addition, the lighting device 200 according to an exemplary embodiment in the present disclosure may further include an analog front end 210, a constant voltage regulator 220, and a digital signal conversion circuit 230. In one exemplary embodiment in the present disclosure, the constant voltage regulator 220 is an element receiving an electrical signal from the NFC device 110 and generating a constant voltage to supply a stable voltage. The constant voltage regulator 220 may manage power and provide a stable constant voltage to the controller 240 and the non-volatile memory 241. The digital signal conversion circuit 230 according to an exemplary embodiment in the present disclosure converts an analog electrical signal generated by the NFC device 110 into a digital signal consisting of 0 and 1, and the analog electrical signal may be converted into a digital signal of 0 or 1 according to a magnitude thereof.

Therefore, the controller 240 according to an exemplary embodiment in the present disclosure may receive a constant voltage transferred from the constant voltage regulator 220 as an input voltage Vin and may be provided with a voltage to be provided to the non-volatile memory NVM 241 through the digital signal received from the digital signal conversion circuit 230. The voltage may be stored in the auxiliary power 270 connected in parallel to the controller 240.

In addition, according to an exemplary embodiment in the present disclosure, the lighting device 200 may further include a first memory 250 storing information necessary to perform the second encrypted RF communications.

In other words, the information necessary for the second encrypted RF communications received from the NFC device 110 may be first stored in the first memory 250, and the RF transceiver 120 may perform pairing for connecting second encrypted RF communications using the information stored in the first memory 250, and when the second encrypted RF communications is connected, lighting device setting information may be received via the second encrypted RF communications. External attacks are prevented by separating a communication channel for pairing and a communication channel for receiving lighting device setting information, and the lighting device setting information received through the encrypted channel is moved from the first memory 250 to the non-volatile memory 241, and the lighting device setting information may be moved to and stored in the volatile memory 242 whenever decrypted, so that tampering by an external attack may be prevented by storing in the plurality of memories.

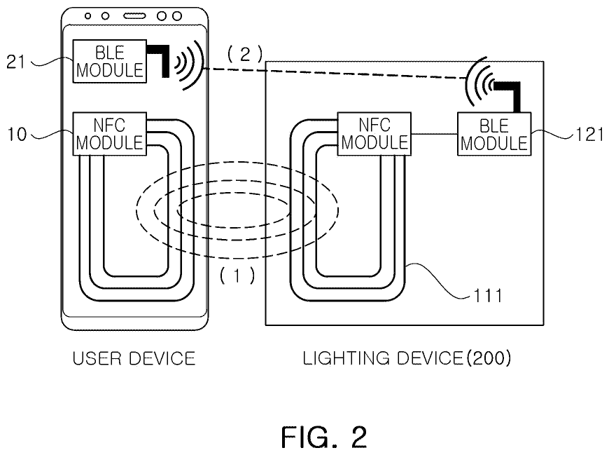

FIG. 2 is a conceptual diagram illustrating pairing between the lighting device 200 performing programming via encrypted communications and a user device according to an exemplary embodiment in the present disclosure, and lighting conditions of the lighting device 200 may be set through the user device used as an NFC programmable unit.

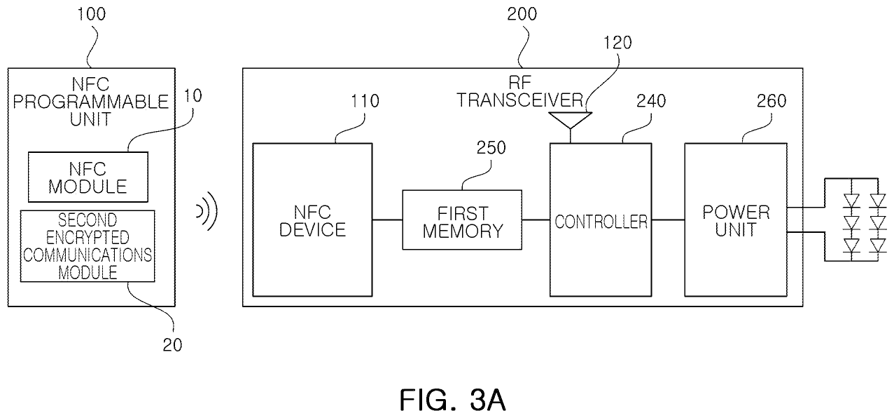

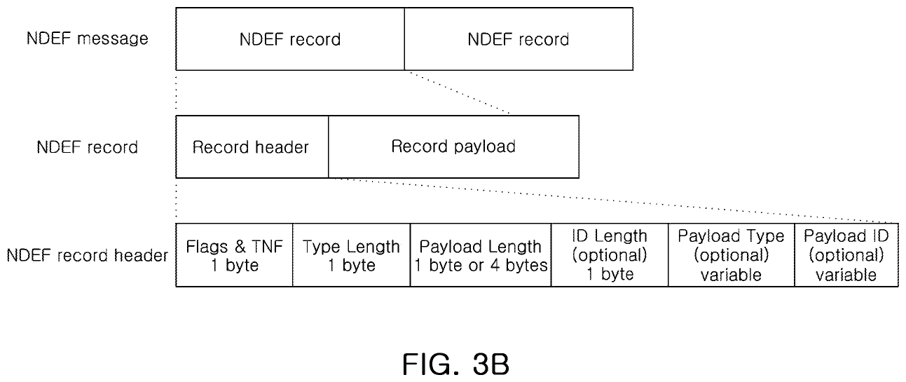

As a specific exemplary embodiment, as illustrated in FIG. 2, (1) an NFC module 10 of the user device and an NFC module 111 as an NFC device 110 of the lighting device 200 perform pairing to perform first RF communications, and (2) when the first RF communications pairing is completed, second encrypted RF communications is performed between a Bluetooth module (or BLE module) 21 of the user device and a Bluetooth module (or BLE module) 121 as the RF transceiver 12 of the lighting device 200 using data received via the first RF communications. The Bluetooth module 21 of the user device is an exemplary embodiment of a second encrypted communications module 20 (refer to FIG. 3A).

The user device may transmit information of the Bluetooth module 21 thereof, such as a device name, a device address, a security key, and the like via the first RF communications.

In other words, the first RF communications for receiving data for performing the second encrypted RF communications and the second encrypted RF communications for receiving the lighting device setting information are separately used, and in the first RF communications pairing process, pairing is performed by including the information on the second encrypted RF communications, thereby strengthening security.

In addition, according to an exemplary embodiment in the present disclosure, such pairing and encrypted communications may be used to control the lighting device 200 by using a user device, such as a mobile phone, a smart device, or a personal digital assistant (PDA).

FIGS. 3A to 5 are diagrams illustrating first RF communications and second encrypted RF communications in a process in which a lighting device performing programming via encrypted communications performs transmission and reception according to an exemplary embodiment in the present disclosure.

As illustrated in FIG. 3A, an NFC programmable unit 100, for example, a user device, such as a mobile phone, a cell phone, or a smart device, may perform first RF communications and second encrypted RF communications with the lighting device 200 through the NFC module 10 or the second encrypted communications module 20, e.g., the Bluetooth module 21 (refer to FIG. 2).

In the lighting device 200, information necessary for the second encrypted RF communications received through the NFC device 110 may be stored in the first memory 250, and the RF transceiver 120 may perform second encrypted RF communications with the NFC programmable unit 100 using the information stored in the first memory 250.

After completion of the second encrypted RF communications pairing, the encrypted lighting device setting information may be received and stored in the controller 240, and the controller 240 may decrypt the stored lighting device setting information to control power supplied by the power unit 260 to a light source.

At this time, as illustrated in FIG. 3B, in the first RF communications, pairing may be performed by exchanging data using a standard NFC data exchange format (NDEF) according to NFC.

The standard NDEF may include an NDEF message, and the NDEF message may include a plurality of NDEF records. The NDEF record may include an NDEF record header and a record payload, and the NDEF record header may include flag & TNF or bytes, such as type length, payload length, ID length, payload type, and payload ID.

In addition, information transmitted from the NFC programmable unit 100 to the lighting device 200 for the second encrypted RF communications, which is transmitted and received via the first RF communications, may include a device name, an address of the device, a security key, and the like, and the security key may be a random value of 16 bytes and a fixed value of 16 bytes.

Thereafter, for the second encrypted RF communications, the RF transceiver 120 of the lighting device 200 may identify advertise information transmitted from the NFC programmable unit 100, and may perform pairing for the second encrypted RF communications using information transmitted from the NFC programmable unit 100 to the lighting device 200. At this time, a pairing process may be set to exchange security information and then encrypt all communications.

For example, the second encrypted RF communications may use an encrypted communications method, such as Bluetooth, proprietary 2.4 GHz, ZigBee, Wi-Fi, 6LowPAN, or proprietary Sub-1 GHz.

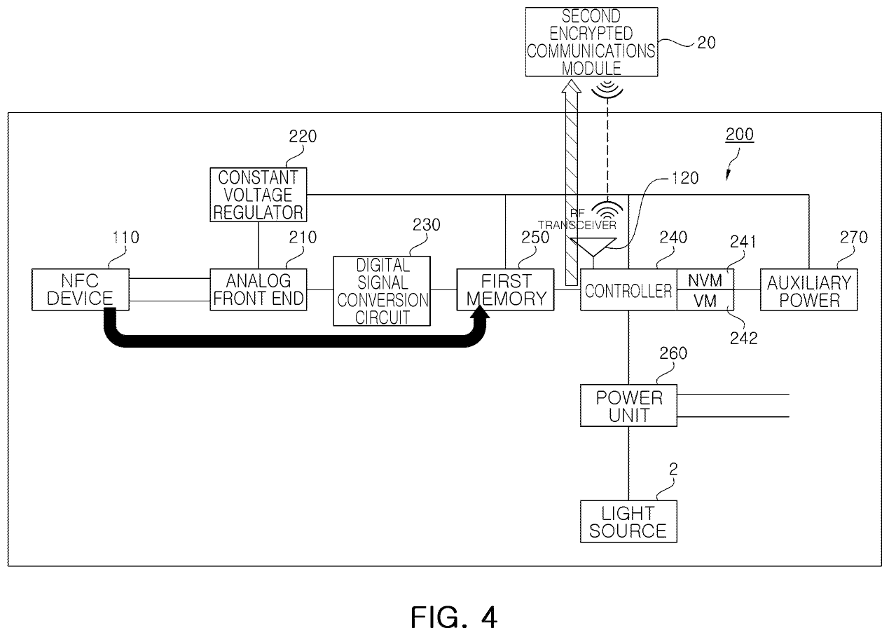

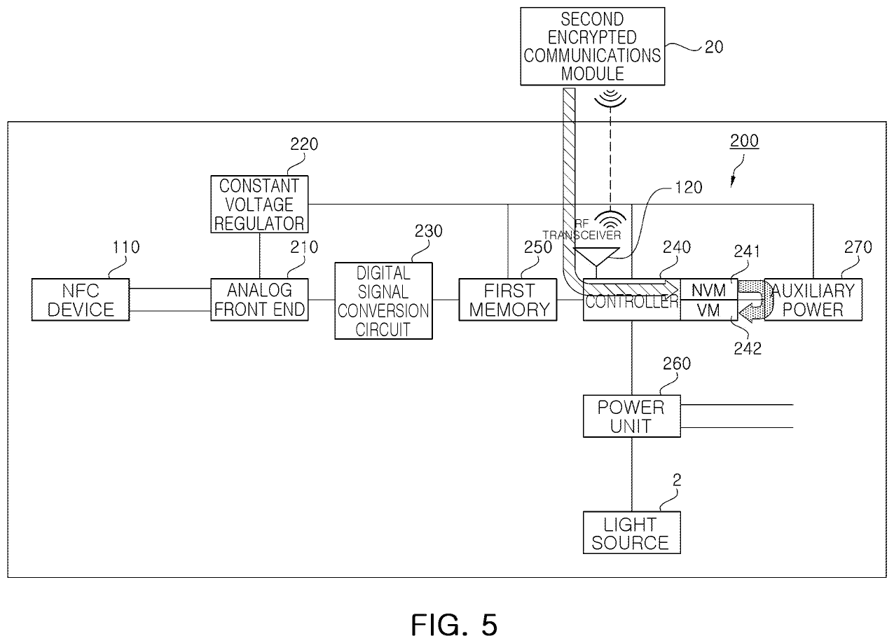

FIGS. 4 and 5 illustrate the process described above as a process of transmitting and receiving data between components within the lighting device 200, and as illustrated in FIG. 4, information necessary for the second encrypted RF communications received by the NFC device 110 for the first RF communications may be stored in the first memory 250.

In this case, the first memory 250 may be a volatile memory. Information necessary for the second encrypted RF communications may be erased without performing a separate erasing operation, and only safety-verified information may be moved to and stored in the non-volatile memory 241 inside the controller 240 to enhance security.

In addition, the RF transceiver 120 may be installed inside the lighting device 200 or provided separately outside the lighting device 200 in order to access the second encrypted RF communications network, and as illustrated in FIG. 4, when the RF transceiver 120 is disposed inside the lighting device 200, the RF transceiver 120 may perform second encrypted RF communications pairing with the external second encrypted communications module 20. That is, a channel for receiving information for the second encrypted communications and an encrypted channel for receiving the lighting device setting information are separated through pairing.

In the case of the second encrypted RF communications network, advanced encryption standard (AES) method may be mainly used for data encryption. For example, encryption may be performed using AES or AES-CCM, and as an encryption algorithm replacing DES, it is a symmetric key algorithm that uses the same key in encryption and decryption processes.

In addition, as illustrated in FIG. 5, when pairing between devices for the second encrypted RF communications is completed, the lighting device 200 may receive encrypted information via the second encrypted RF communications and immediately store the information in the non-volatile memory 241 of the controller 240, rather than storing it in the first memory 250, so that only the encrypted information may be stored in the non-volatile memory 241. By storing verified information through an encrypted channel in the non-volatile memory 241, cumbersome work, such as rewriting data, may be reduced.

In addition, as illustrated in FIG. 5, information obtained by decrypting the encrypted information stored in the non-volatile memory 241 may be temporarily stored in the volatile memory 242, instead of the non-volatile memory 241, and since the information is stored in the volatile memory 242, the information may be automatically deleted after power is cut off, without a separate erasing operation. Since the information is decrypted only when necessary in the lighting device 200 and may be immediately erased by temporarily powering off without a separate operation, security may be enhanced.

That is, the data stored in the non-volatile memory 241 is encrypted and protected from external attackers, and is decrypted using the AES method so that the information is temporarily stored to be used in the volatile memory 242, and when power is cut off, the information is lost not to be exposed to external attackers.

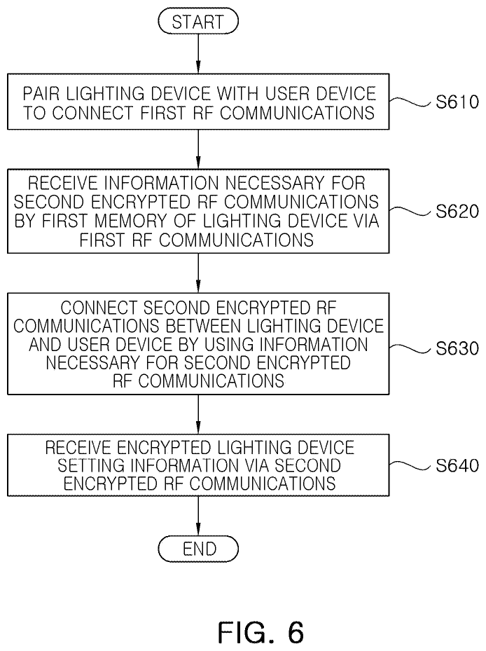

FIG. 6 illustrates a method for programming a lighting device via encrypted communications according to an exemplary embodiment in the present disclosure.

As illustrated in FIG. 6, a method for programming a lighting device 200 via encrypted communications according to an exemplary embodiment in the present disclosure includes pairing the lighting device 200 with a user device to connect first radio frequency (RF) communications (S610), receiving information necessary for second encrypted RF communications by a first memory 250 of the lighting device 200 via the first RF communications (S620), connecting second encrypted RF communications between the lighting device 200 and the user device by using the information necessary for the second encrypted RF communications (S630), and receiving encrypted lighting device setting information via the second encrypted RF communications (S640).

In operation S640, encrypted lighting device setting information may be stored in the non-volatile memory 241 inside the controller 240 of the lighting device 200 via the second encrypted RF communications.

In addition, as an exemplary embodiment, the method may further include decrypting the encrypted lighting device setting information stored in the non-volatile memory 241 and transferring and storing the decrypted lighting device setting information in the volatile memory 242 inside the controller 240, and power supplied to a light source in the lighting device may be controlled based on the decrypted lighting device setting information stored in the volatile memory. Redundant descriptions herein will be omitted.

The receiving of the information necessary for second encrypted RF communications by the first memory 250 of the lighting device 200 via the first RF communications may include receiving information of the Bluetooth module 21 embedded in the user device via the first RF communications so that the Bluetooth module 121 embedded in the lighting device 200 performs encrypted communications with the Bluetooth module 21 embedded in the user device.

The information of the Bluetooth module 21 embedded in the user device may include a name and address of the Bluetooth device and an encryption key for secure connection.

In addition, according to an exemplary embodiment in the present disclosure, the encrypted lighting device setting information received via the second encrypted RF communications may include a security encryption key, interworking device information, and lighting setting information, and the lighting setting information may include at least one of an output current of the light source 2, an operating mode, a minimum dimming level, an overpower limit, an internal/external overtemperature protection, a start-up time, auxiliary output, and end of life.

Specifically, the output current is a parameter for setting a maximum output current of the constant current light source 2, and the operating mode may include an analog dimming mode performing a brightness control operation according to an analog input signal, a time dimming mode automatically operating according to a preset time, and a smart module mode operating with a control signal, such as Wi-Fi or Bluetooth through a separate device, and at least one of the modes may be set according to a received operating mode data.

In addition, the minimum dimming level is a parameter for setting a minimum dimming level, the overpower limit is a parameter for setting a minimum or maximum output limit setting value, and the internal/external overtemperature protection is a parameter for setting a resistance value at protection operation start and end points of a negative temperature coefficient (NTC) device installed inside and outside, which changes according to temperature, and a minimum output brightness.

The start-up time is a parameter for setting a time required from when AC power is applied to a product until lighting is completed, the auxiliary output is a parameter for setting an output voltage specification of auxiliary power supplied by the power unit 260 for an external device, and the end of life is a parameter for setting the life-time information of a product.

The security encryption key according to an exemplary embodiment in the present disclosure may include a public key, a personal key, a product identification number, a product name, a user name, a communication method, an encryption key, a pin code, and channel information personal area network identifier (PAN ID).

In addition, interworking device information according to an exemplary embodiment in the present disclosure may include interworking information of a remote controller, interworking information of a switch, interworking information of a human detect sensor, and the like.

In addition, the encrypted lighting device setting information received via the second encrypted RF communications according to an exemplary embodiment in the present disclosure may further include a control signal, and the control signal may include a light source 2 ON/OFF signal, brightness control, color temperature control, fade-in/out control, and scene control.

In this case, the first RF communications may be an NFC method using an NDEF, and the second encrypted RF communications may be wireless communication to which an AES encryption method is applied. For example, the second encrypted RF communications may be wireless communication, such as Bluetooth, Wi-Fi, or ZigBee to which AES encryption is applied.

Meanwhile, a process of supplying power between the auxiliary power 270 of the lighting device 200 and the controller 240 according to an exemplary embodiment in the present disclosure will be described.

The controller 240 according to an exemplary embodiment in the present disclosure may further include a monitoring unit (not illustrated) monitoring whether or not the digital signal transmits and receives a signal of the NFC device 110, and when the digital signal detects signal transmission and reception, power included in the signal or a separate external power source supplies power to the auxiliary power source 270, and if the digital signal does not detect signal transmission/reception, the controller 240 may receive backup power of the auxiliary power 270.

That is, in the present disclosure, data directly transmitted through NFC is not directly stored in a non-volatile memory (e.g., EEPROM), but information necessary for accessing a second communication network is received through NFC and stored in a volatile memory, and thereafter, various security authentication keys and device setting information located in the second communication network is stored in a non-volatile memory via encrypted communications using the stored information, thereby preventing information leakage through the use of non-encrypted communications.

According to an exemplary embodiment in the present disclosure, in the process of setting lighting device setting information in the lighting device, the security authentication key and related data for communication with the server are prevented from being leaked to the outside while the lighting device setting information is easily set in the lighting device, so that an attacker cannot arbitrarily operate or leak the lighting device setting information of the lighting device.

While example exemplary embodiments have been illustrated and described above, it will be apparent to those skilled in the art that modifications and variations could be made without departing from the scope of the present disclosure as defined by the appended claims.

What is claimed is:

1. A method for programming a lighting device via encrypted communications, the method comprising:
pairing the lighting device with a user device to connect first radio frequency (RF) communications;
receiving information necessary for second encrypted RF communications in a first memory of the lighting device via the first RF communications;
connecting the second encrypted RF communications between the lighting device and the user device by using the information necessary for the second encrypted RF communications; and
receiving encrypted lighting device setting information via the second encrypted RF communications.

2. The method of claim 1, wherein
the receiving of the encrypted lighting device setting information via the second encrypted RF communications includes storing the encrypted lighting device setting information in a non-volatile memory inside of a controller of the lighting device via the second encrypted RF communications.

3. The method of claim 2, further comprising:
decrypting the encrypted lighting device setting information stored in the non-volatile memory and transferring and storing the decrypted lighting device setting information in a volatile memory inside the controller.

4. The method of claim 3, wherein
power supplied to a light source in the lighting device is controlled based on the decrypted lighting device setting information stored in the volatile memory.

5. The method of claim 1, wherein
the receiving of the information necessary for second encrypted RF communications in the first memory of the lighting device via the first RF communications includes receiving information of a Bluetooth module embedded in the user device via the first RF communications so that a Bluetooth module embedded in the lighting device performs encrypted communications with the Bluetooth module embedded in the user device.

6. The method of claim 5, wherein
the information of the Bluetooth module embedded in the user device includes a name and address of the Bluetooth device and an encryption key for secure connection.

7. The method of claim 1, wherein
the encrypted lighting device setting information received via the second encrypted RF communications includes a security encryption key, interworking device information, and lighting setting information, and
the lighting setting information includes at least one of an output current of a light source, an operating mode, a minimum dimming level, an overpower limit, an internal/external overtemperature protection, a start-up time, and auxiliary output.

8. The method of claim 1, wherein
the first RF communications is a near-field communication (NFC) method using NFC data exchange format (NDEF), and the second encrypted RF communications is wireless communication to which an advanced encryption standard (AES) encryption method is applied.

9. A lighting device for performing programming via encrypted communications, the lighting device comprising:
a near-field communication (NFC) device performing first radio frequency (RF) communications for receiving information necessary for second encrypted RF communications;
an RF transceiver performing pairing through information necessary for the second encrypted RF communications and receiving encrypted lighting device setting information after completing the second encrypted RF communications pairing; and
a power unit receiving power from the outside according to the encrypted lighting device setting information and supplying power to at least one light source.

10. The lighting device of claim 9, further comprising:
a controller including a non-volatile memory storing the received encrypted lighting device setting information and a volatile memory decrypting the lighting device setting information and storing the decrypted lighting device setting information, the controller controlling an operation of the power unit according to the received lighting device setting information.

11. The lighting device of claim 10, further comprising:
a first memory storing information necessary to perform the second encrypted RF communications.
